(19) United States
(12) Patent Application Publication
(10) Pub. No.: US 2020/0232551 A1
(43) Pub. Date: Jul. 23, 2020

(54) Arrangement for Construction of Wing Drum

(71) Applicant: ABB Schweiz AG, Baden (CH)

(72) Inventor: Galen Burdeshaw, Simpsonville, SC (US)

(73) Assignee: ABB Schweiz AG, Baden (CH)

(21) Appl. No.: 16/254,009

(22) Filed: Jan. 22, 2019

(51) Int. Cl. F16H 55/17

(52) U.S. Cl. CPC F16H 55/17; F16H 2055/175; F16H 55/171

(57) ABSTRACT

A rotatable industrial drum includes a rotatable drum with an outer peripheral surface, a plurality of elongated retention devices disposed parallel to one another along and secured to the outer peripheral surface, and a plurality of elongated wing assemblies disposed adjacent and retained by the retention devices. Each retention device includes at least one retention flange spaced from the outer peripheral surface of the drum and defining an elongated axially-extending retention chamber along a side of the respective elongated retention device. The elongated wing assembles includes an enlarged base from which a wing extends in a generally radial direction from the drum, the enlarged base extending laterally outward from either side of the wing being disposed within and between the elongated axially-extending retention chambers of at least two of the plurality of elongated retention devices disposed along either side of a respective elongated wing assembly.

### TECHNICAL FIELD

This patent disclosure relates generally to rotatable drums and, more particularly to arrangements for constructing a rotatable drum including a plurality of outwardly extending wings.

### BACKGROUND

Rotatable drums are utilized in many industrial applications, including, for example, drum pulleys. Such rotatable drums may include a textured or smooth outer surface. Wing drums include a plurality of outwardly extending wings. The wings may be utilized to engage and advance objects such as a movably mounted belt or individual objects.

Standard wing drums or pulleys are disclosed, for example, in U.S. Pat. Nos. 3,363,476 and 4,956,914. Standard wing pulleys require a significant number of individual pieces that must be coupled together in order to construct the final pulley. Accordingly, standard wing pulleys are expensive to fabricate due to high labor content and the extensive inventory required to support production. Moreover, significant inventory investment is required, both in terms of raw goods inventory, as well as finished product inventory of various sizes of pulleys. These costs are magnified when constructing wing pulleys of various sizes or lengths.

### SUMMARY

The disclosure describes, in one aspect, a rotatable industrial drum that includes a drum having an outer peripheral surface and being adapted to rotate about an axis, a plurality of elongated retention devices, and a plurality of elongated wing assemblies. The plurality of elongated retention devices are disposed parallel to one another along and secured to the outer peripheral surface of the drum. Each retention device includes at least one retention flange spaced from the outer peripheral surface, and defines an elongated axially-extending retention chamber along a side of the respective elongated retention device. Each of the plurality of elongated wing assemblies includes an enlarged base from which a wing extends in a generally radial direction from the drum. The enlarged base extending laterally outward from either side of the wing. The enlarged bases of each of the elongated wing assemblies are disposed within and between the elongated axially-extending retention chambers of at least two of the plurality of elongated retention devices disposed along either side of a respective elongated wing assembly.

Another aspect of the invention provides a method of constructing a wing drum including the steps of providing a drum having an outer peripheral surface and being adapted to rotate about an axis, disposing a plurality of elongated retention devices substantially parallel to one another in a longitudinal direction along the outer peripheral surface and securing the plurality of elongated retention devices to the outer peripheral surface, each of the plurality of elongated retention devices forming a retention chamber along at least one side of the respective elongated retention device, providing a plurality of elongated contact wing assemblies each including an enlarged base from which a wing extends, the enlarged base extending outward from opposite sides of the elongated contact wing assembly, disposing the enlarged base of a first elongated contact wing assembly of the plurality of contact wing assemblies within the retention chambers of elongated retention devices disposed along opposite sides of the first elongated contact wing assembly, and disposing the enlarged base of a second elongated contact wing assembly of the plurality of contact wing assemblies within the retention chambers of elongated retention devices disposed along opposite sides of the second elongated contact wing assembly, whereby the respective wings of the plurality of elongated contact wing assemblies extend in a generally radial direction from the drum.

In yet another aspect, the invention provides a wing pulley that includes a drum pulley having an outer peripheral surface and being adapted to rotate about an axis, along with a plurality of elongated retention devices, and a plurality of elongated replaceable wing assemblies. The plurality of elongated retention devices are disposed in an axial direction and secured to the outer peripheral surface of the drum pulley. Each retention device includes at least one flange spaced from the outer peripheral surface to define an elongated axially-extending retention chamber between the at least one flange and the outer peripheral surface. The plurality of elongated retention devices are disposed parallel to one another to define facing substantially parallelly-disposed retention chambers between adjacent ones of the plurality of elongated retention devices. Each elongated wing assembly includes an enlarged base from which extends a generally radially-extending wing. The enlarged base extends outward from either side of the generally radially-extending wing. The enlarged base of each of the wing assemblies is disposed within and retained against the outer peripheral surface of the drum pulley by the facing parallelly-disposed retention chambers of adjacent retention devices.

### BRIEF DESCRIPTION OF THE DRAWING(S)

FIG. 1 is an isometric view of a standard rotatable drum in the form of a drum pulley.

FIG. 2 is a schematic isometric view of an embodiment of a rotatable drum having a plurality of wings, and, more particularly, a wing pulley.

FIG. 3 is a schematic end view of the rotatable drum of FIG. 2.

FIG. 4 is an enlarged isometric view of an embodiment of a retention device of the rotatable drum of FIGS. 2 and 3.

FIG. 5 is an enlarged isometric view of an embodiment of a wing assembly of the rotatable drum of FIGS. 2 and 3.

FIG. 6 is an enlarged fragmentary isometric view of a wing assembly and a pair of retention devices coupled to an outer peripheral surface of a drum.

FIG. 7 is an enlarged fragmentary isometric view of a wing assembly and a pair of retention devices coupled to an outer peripheral surface of a drum and including a coupling clamp.

FIG. 8 is an enlarged fragmentary isometric view of a wing assembly and a pair of retention devices coupled to an outer peripheral surface of a drum and including a retention plate.

### DETAILED DESCRIPTION

This disclosure relates to rotatable drums, and, in a more specific embodiment, to rotatable drum pulleys. Referring first to FIG. 1, there is illustrated a rotatable drum 10. While a standard rotatable drum pulley is illustrated, the rotatable drum 10 may be any type of industrial drum adapted to be rotatable about an axis A. The rotatable drum 10 includes an outer peripheral surface 12 with opposed end faces 14, only one end face being visible in FIG. 1. This embodiment of a rotatable drum 10 additionally includes an annular flange 16 between the end face 14 and the peripheral surface 12. The outer peripheral surface 12 defines the length L_{D} and outer diameter D of the drum 10. The drum 10 is typically formed of a relatively rigid material, such as steel, aluminum, or a metal alloy.

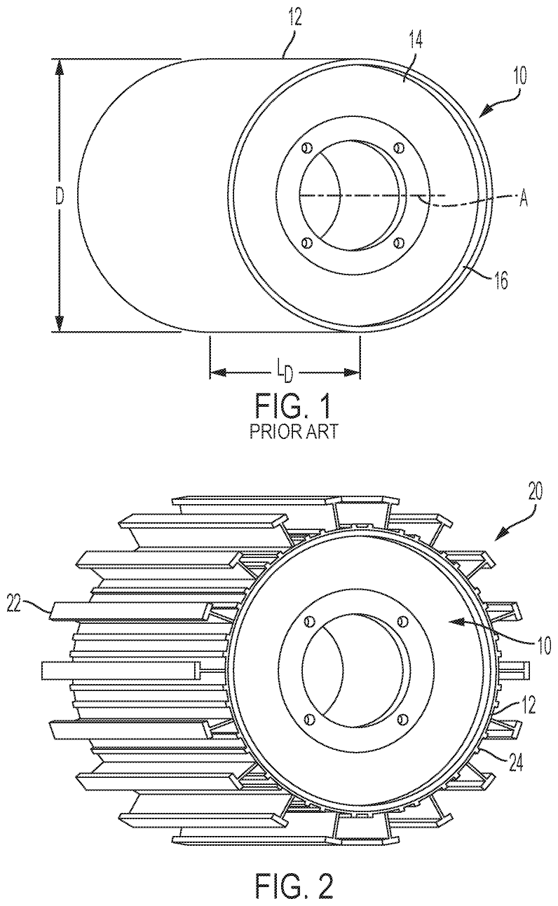

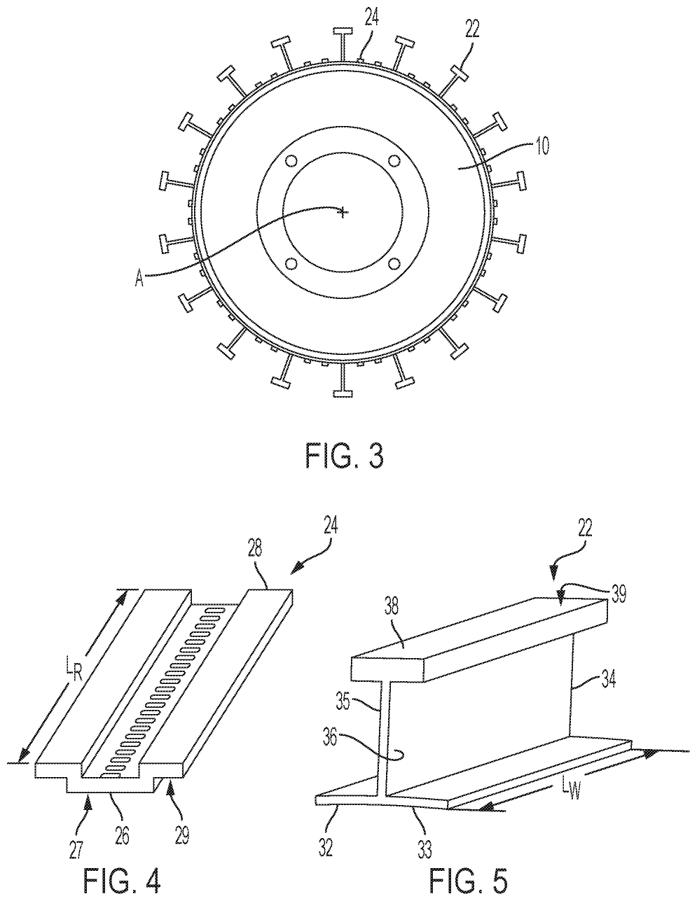

In accordance with invention, the standard rotatable drum 10 may be converted to a wing drum 20, as illustrated, for example, in FIGS. 2 and 3. In the embodiment of FIGS. 2 and 3, a plurality of elongated wing assemblies 22 are coupled to the peripheral surface 12 of the drum 10 by a plurality of retention devices 24.

In this embodiment, a plurality of elongated retention devices 24 are provided. The elongated retention devices 24 are disposed generally parallel to one another along and secured to the outer peripheral surface 12 of the drum 10. Turning to FIG. 4, there is illustrated an exemplary retention device 24 each have a length L_{R}. The retention devices 24 may be formed of any appropriate substantially rigid material, such as steel, aluminum, or metal alloy, for example. While other designs may be provided, in this embodiment the elongated retention device 24 includes a base 26 from which an at least one retention flange 28 extends. In the illustrated embodiment, retention flanges 28 are provided along either side of the base 26. The base 26 includes a lower surface 27, while the retention flanges 28 include a lower surface 29 which is spaced away from the lower surface 27 of the base 26.

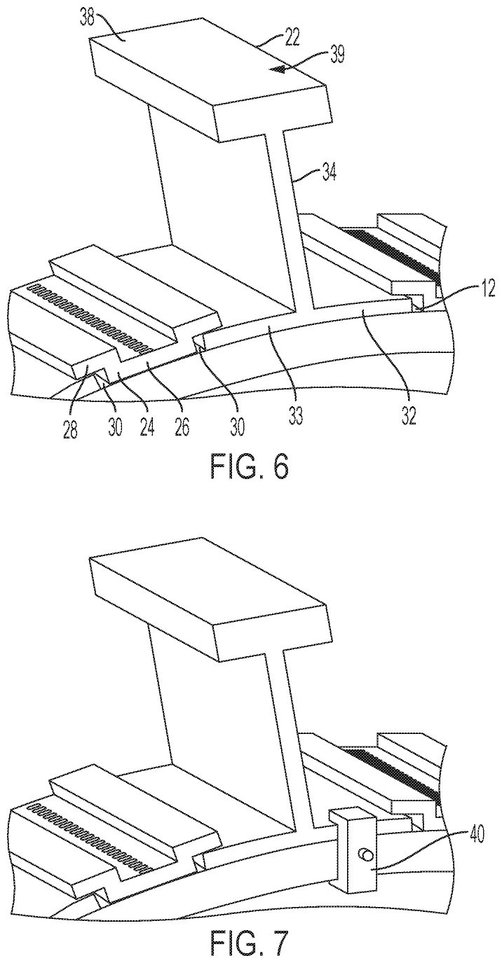

In assembly, the lower surface 27 of the base 26 of the retention device 24 is disposed against the peripheral surface 12 of the drum 10, and the retention device 24 is secured to the drum 10 by any appropriate method. By way of example only, the base 26 of the retention devices 24 may be secured to the peripheral surface 12 by tack welding, riveting, or bolting. In this way, the lower surfaces 29 of the retention flanges 28 are spaced from the outer peripheral surface 12 to define an elongated axially-extending retention chamber 30 between the retention flange 28 and the outer peripheral surface 12, that is, along a side of the elongated retention device 24 (see FIG. 6). In the illustrated embodiment, the retention device 24 includes retention flanges 28 along either side of the base 26, and, accordingly, retention chambers 30 are formed along both sides of the retention device 24. It will be appreciated by those of skill in the art, however, that a pair of retention devices, each including only one such elongated retention flange may be disposed in a parallel arrangement to likewise provide retention chambers along either side of the pair of parallelly disposed retention flanges.

Turning now to FIG. 5, there is illustrated an exemplary elongated wing assembly 22 having a length L_{W}. The elongated wing assembly 22 includes an enlarged base 32 from which a wing 34 extends. The illustrated enlarged base 32 includes wing base flanges 33 extending laterally outward from either side of the wing 34. While the wing 34 extends from the enlarged base 32 at approximately a right angle in the illustrated embodiment, it will be appreciated that the wing 34 may extend from the enlarged base 32 at an alternate angle. For example, the wing 34 may extend at an acute angle along one side of the wing 34 and an obtuse angle along the other side in order to provide a lagged arrangement. Further, while the wing 34 includes generally parallel faces 35, 36 in the illustrated embodiment, the wing 34 may include faces 35, 36 that are not parallel. For example, the faces may be angled toward one another to provide a triangular shape.

The wing assembly 22 may additionally include a contact bar 38 along the outer edge of the wing 34. Such contact bars 38 may be of any appropriate design. By way of example only, the contact bars 38 may optionally include a substantially flat or planar outer surface 39, a crowned surface, or a crowned surface. Moreover, the outer surface 39 may have any appropriate configuration. For example, the outer surface 39 may be smooth, textured, high traction, or treated with a ceramic tip for increased traction or wear resistance. The contact bar 38 or the outer tip of the wing 34 may be hardened.

Additionally, the outer surface of the wing assembly 22, here, the outer surface 39 of the contact bar 38 of the wing assembly 22, may be straight (as illustrated) or include an edge crown (not illustrated). That is, the opposite ends of the wing assembly 22 may include an edge crown. Those of skill in the art will appreciate that an edge crown may assist in belt alignment. The wing assemblies 22 may be formed of any appropriate substantially rigid material, such as steel, aluminum, or metal alloy. The wing assemblies 22 may be I-beams, castings, forgings, or fabrications resulting from any appropriate method.

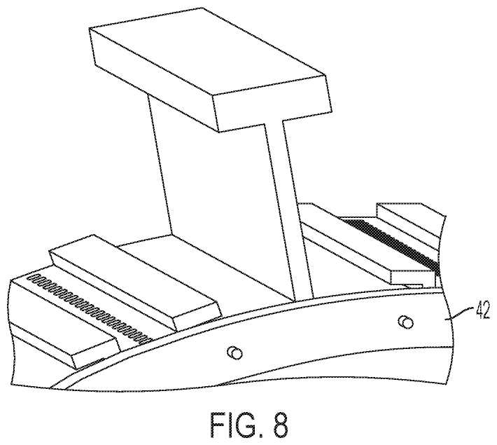

In assembly, the enlarged base 32 of the elongated wing assembly 22 is inserted within and between the elongated axially-extending retention chambers 30 of at least two of the plurality of elongated retention devices 24 disposed along either side of the elongated wing assembly 22, as illustrated, for example, in FIG. 6. When installed on the drum 10, the wings 34 extend in a generally radial direction from the drum 10. It will be appreciated that whether the wing 34 extends perpendicularly from the enlarged base 32 or at an alternative angle to the enlarged base 32, the wing 34 is still extending outward, that is, in a generally radial direction from the drum 10. While elongated wing assembly 22 may be retained axially by pressure from the adjacent retention devices 24, the elongated wing assembly 22 may additionally be coupled to the annular flange 16 or end face 14 of the drum 10 by a mechanical clamp 40 (e.g., FIG. 7) or a retention plate 42 (e.g., FIG. 8) coupled to the annular flange 16 or the end face 14 of the drum 10 by any appropriate mechanism.

### INDUSTRIAL APPLICABILITY

The present disclosure is applicable to the conversion of rotatable industrial drums 10 to wing drums 20, and, in a more particular application, the conversion of drum pulleys to wing pulleys. The present disclosure presents a wing drum structure, a wing pulley structure, and a method for constructing a wing drum.

The present disclosure invention supports modular assembly of a wing drum 20. Retention devices 24 and wing assemblies 22 of a standardized length or lengths L_{R}, L_{W} and edge surfaces, such as straight, crowned or edge crowned, can be retained and stacked depending on the length L_{D} of one or more rotatable drums or drum pulleys. Those of skill in the art will appreciate that retention devices 24 and wing assemblies 22 may also be applied to a rotatable industrial drum 10 or drum pulley in a substantially end-to-end fashion to permit the conversation of industrial drums or drum pulleys of varied lengths. That is, for a drum 10 of length L_{D}, a plurality of retention devices 24 of length L_{R} may be applied in an end-to-end fashion along the outer peripheral surface 12 of the drum 10 where, for example, L_{D}=xL_{W}, where x is greater than 1. Similarly, for a drum 10 of length L_{D}, a plurality of wing assemblies 22 of length L_{R} may be applied in an end-to-end fashion along the outer peripheral surface 12 of the drum 10 where, for example, L_{D}=xL_{W}, where x is greater than 1.

Further, while the illustrated embodiments show retention devices 24 and wing assemblies 22 applied to a drum 10 substantially parallel fashion along the entire length of the drum 10, those of skill in the art will appreciate that the retention devices 24 and wing assemblies 22 may be applied to a drum 10 in an alternate fashion, such as a herringbone or spiral arrangement. Those of skill in the art will appreciate that, in such arrangements, the retention devices 24 and wing assemblies 22 would be typically be applied in a parallel fashion along discrete lengths of the drum 10. Moreover, it will be appreciated that the retention devices 24 and wing assemblies 22 in each such arrangement would still typically be disposed parallel to the axis of rotation of the drum 10.

In accordance with aspects of this disclosure, finished rotatable industrial drums 10 or drum pulleys in inventory may be readily converted to wing drums 20 or wing pulleys, respectively. Likewise, rotatable industrial drums 10 or drum pulleys may be converted to wing drums 20 or wing pulleys, respectively, in the field. In accordance with another aspect of the disclosure, wing drums 20 or wing pulleys having damaged wing assemblies 22 or retention devices 24, whether in the field or in inventory, may be readily replaced individually, rather than replacement of the entire wing drum 20 or wing pulley. In this way, the disclosed arrangement may minimize downtime inasmuch as the wing drum 20 or wing pulley and shaft assembly may not need to be removed for replacement or repair.

Further, inasmuch as the retention devices 24 and wing assemblies 22 may be provided in a standardized sizes that may be usable in the construction of a range of sizes of rotatable industrial drums 20 or drum pulleys, the present disclosure may present advantages in the reduction of finished goods and raw good inventory.

Further, in accordance with aspects of this disclosure, a standard rotatable industrial drum 10 or drum pulley to be field-converted for specific customer needs and preferences rather than have to custom build a wing drum 20 or wing pulley. A standard rotatable industrial drum 10 or drum pulley may be converted to a desired configuration in a relatively short time from a limited number of stock products to provide custom builds.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

I claim:

1. A rotatable industrial drum comprising:
a drum having an outer peripheral surface and being adapted to rotate about an axis,
a plurality of elongated retention devices disposed parallel to one another along and secured to the outer peripheral surface, each retention device including at least one retention flange spaced from the outer peripheral surface and defining an elongated axially-extending retention chamber along a side of the respective elongated retention device, and
a plurality of elongated wing assemblies, each elongated wing assembly including an enlarged base from which a wing extends in a generally radial direction from the drum, the enlarged base extending laterally outward from either side of the wing,
wherein the enlarged bases of each of the elongated wing assemblies are disposed within and between the elongated axially-extending retention chambers of at least two of the plurality of elongated retention devices disposed along either side of a respective elongated wing assembly.

2. The rotatable industrial drum of claim 1 wherein the drum is a conventional drum pulley.

3. The rotatable industrial drum of claim 1 wherein the elongated retention devices each include a retention base, the at least one retention flange being offset from the retention base, the retention base being secured to the outer peripheral surface.

4. The rotatable industrial drum of claim 3 wherein at least a portion of the plurality of elongated retention devices include retention flanges extending along either side of the retention base.

5. The rotatable industrial drum of claim 1 wherein the elongated axially-extending retention chamber is formed by and between the at least one retention flange and the outer peripheral surface.

6. The rotatable industrial drum of claim 1 wherein the plurality of elongated retention devices are secured to the outer peripheral surface by at least one of welding, riveting, and bolting.

7. The rotatable industrial drum of claim 1 wherein the enlarged base of each of the plurality of elongated wing assemblies includes at least one wing base flange extending outward from either side of the respective elongated wing assembly.

8. The rotatable industrial drum of claim 1 wherein at least a portion of the enlarged base of each of the elongated wing assemblies is disposed against the outer peripheral surface.

9. The rotatable industrial drum of claim 1 wherein the elongated retention devices extend axially and at least partially about the circumference of the drum along the outer peripheral surface.

10. The rotatable industrial drum of claim 1 wherein the elongated wing assemblies extend axially and at least partially about the circumference of the drum.

11. The rotatable industrial drum of claim 1 wherein the elongated wing assemblies are formed of steel.

12. The rotatable industrial drum of claim 1 further including at least one plate secured to an end surface of the drum.

13. A method of constructing a wing drum comprising the steps of:
providing a drum having an outer peripheral surface and being adapted to rotate about an axis,
disposing a plurality of elongated retention devices substantially parallel to one another in a longitudinal direction along the outer peripheral surface and securing the plurality of elongated retention devices to the outer peripheral surface, each of the plurality of elongated retention devices forming a retention chamber along at least one side of the respective elongated retention device,
providing a plurality of elongated contact wing assemblies each including an enlarged base from which a wing extends, the enlarged base extending outward from opposite sides of the elongated contact wing assembly,
disposing the enlarged base of a first elongated contact wing assembly of the plurality of contact wing assemblies within the retention chambers of elongated retention devices disposed along opposite sides of the first elongated contact wing assembly, and
disposing the enlarged base of a second elongated contact wing assembly of the plurality of contact wing assemblies within the retention chambers of elongated retention devices disposed along opposite sides of the second elongated contact wing assembly,
whereby the respective wings of the plurality of elongated contact wing assemblies extend in a generally radial direction from the drum.

14. The method of claim 13 wherein the steps of disposing the enlarged base of the first elongated contact wing assembly and disposing the enlarged base of the second elongated contact wing assembly include removably disposing the enlarged bases of the first and second elongated contact wing assemblies.

15. The method of claim 13 further including removably disposing the enlarged bases of each of the plurality of elongated contact wing assemblies within the retention chambers of elongated retention devices disposed along opposite sides of the respective one of the plurality of elongated contact wing assemblies.

16. The method of claim 13 wherein the step of securing the plurality of elongated retention devices to the outer peripheral surface includes at least one of welding, riveting, bolting.

17. The method of claim 13 wherein the step of disposing and securing the plurality of elongated retention devices includes disposing a retention base of an elongated retention device against the outer peripheral surface and form the retention chamber between the outer peripheral surface and at least one retention flange of the elongated retention device, the at least one retention flange being offset from the retention base.

18. The method of claim 13 further including securing at least one plate to an end surface of the drum.

19. A wing pulley comprising:
a drum pulley having an outer peripheral surface and being adapted to rotate about an axis,
a plurality of elongated retention devices, the plurality of elongated retention devices being disposed in an axial direction and secured to the outer peripheral surface, each retention device including at least one flange spaced from the outer peripheral surface to define an elongated axially-extending retention chamber between the at least one flange and the outer peripheral surface, the plurality of elongated retention devices being disposed parallel to one another to define facing substantially parallelly-disposed retention chambers between adjacent ones of the plurality of elongated retention devices,
a plurality of elongated replaceable wing assemblies, each elongated wing assembly including an enlarged base from which extends a generally radially-extending wing, the enlarged base extending outward from either side of the generally radially-extending wing,
wherein the enlarged base of each of the wing assemblies is disposed within and retained against the outer peripheral surface of the drum pulley by the facing parallelly-disposed retention chambers of adjacent retention devices.

20. The wing pulley of claim 19 wherein the plurality of wing assemblies each include a contact bar disposed at an outer radial edge of the respective wing.
